(19) United States
(12) Patent Application Publication
(10) Pub. No.: US 2018/0261019 A1
(43) Pub. Date: Sep. 13, 2018

(54) METHOD AND APPARATUS FOR TRANSMITTING DATA OF SELF-DRIVING VEHICLE, DEVICE AND STORAGE MEDIUM

(71) Applicant: BAIDU ONLINE NETWORK TECHNOLOGY (BEIJING) CO., LTD., Beijing (CN)

(72) Inventors: Hanlin Yang, Beijing (CN); Gaifan Li, Beijing (CN); Chengfa Wang, Beijing (CN); Jiming Mao, Beijing (CN); Ning Yu, Beijing (CN); Heng Zhang, Beijing (CN)

(73) Assignee: BAIDU ONLINE NETWORK TECHNOLOGY (BEIJING) CO., LTD., Beijing (CN)

(21) Appl. No.: 15/914,881

(22) Filed: Mar. 7, 2018

(30) Foreign Application Priority Data
Mar. 13, 2017 (CN) 201710146477.4

(51) Int. Cl. G07C 5/00; G07C 5/08; H04L 29/06

(52) U.S. Cl. CPC G07C 5/008; H04L 65/4023; G07C 5/0858

(57) ABSTRACT

The present disclosure provides a method and apparatus for transmitting data of a self-driving vehicle, a device and a storage medium, wherein the method comprises: distinguishing data generated during travel of the self-driving vehicle into real-time data and non-real-time data; transmitting the real-time data into a server through a wireless network in real time; storing the non-real-time data into a vehicle-mounted storage device so that after the self-driving vehicle ends travel, the data stored in the vehicle-mounted storage device are transmitted into the server in a predetermined manner. The solution of the present application may be applied to ensure data integrity.

The present application claims the priority of Chinese Patent Application No. 201710146477.4, filed on Mar. 13, 2017, with the title of “Method and apparatus for transmitting data of self-driving vehicle, device and storage medium”, the entire disclosure of which is hereby incorporated by reference in its entirety.

### FIELD OF THE DISCLOSURE

The present disclosure relates to self-driving vehicle technologies, and particularly to a method and apparatus for transmitting data of a self-driving vehicle, a device and a storage medium.

### BACKGROUND OF THE DISCLOSURE

A self-driving vehicle, also called a driverless vehicle means sensing a surrounding environment of a vehicle through various sensors, and controlling a steering direction and a speed of the vehicle according to information about roads, vehicle positions and obstacles obtained by sensing, so that the vehicle can safely and reliably travel on the road.

During travel of the self-driving vehicle, massive data will be generated, and each type of data is of great analysis and research value. According to a processing manner in the prior art, usually the data will be transmitted into a server via a wireless network.

However, since the bandwidth, speed and stability of current wireless transmission are very limited, so only a very small portion of data can be transmitted into the server via the wireless network, and remaining data cannot be transmitted, thereby destroying data integrity and causing loss of a lot of valuable data.

### SUMMARY OF THE DISCLOSURE

In view of the above, the present disclosure provides a method and apparatus for transmitting data of a self-driving vehicle, a device and a storage medium, which can ensure data integrity.

Specific technical solutions are as follows:

A method of transmitting data of a self-driving vehicle, comprising:

distinguishing data generated during travel of the self-driving vehicle into real-time data and non-real-time data;

transmitting the real-time data into a server through a wireless network in real time;

storing the non-real-time data into a vehicle-mounted storage device so that after the self-driving vehicle ends travel, the data stored in the vehicle-mounted storage device are transmitted into the server in a predetermined manner.

An apparatus for transmitting data of a self-driving vehicle, comprising: a pre-processing unit, a first transmitting unit and a second transmitting unit;

the pre-processing unit is configured to distinguish data generated during travel of the self-driving vehicle into real-time data and non-real-time data, transmit the real-time data to the first transmitting unit, and transmit the non-real-time data to the second transmitting unit;

the first transmitting unit is configured to transmit the real-time data into a server through a wireless network in real time;

the second transmitting unit is configured to store the non-real-time data into a vehicle-mounted storage device so that after the self-driving vehicle ends travel, the data stored in the vehicle-mounted storage device are transmitted into the server in a predetermined manner.

A computer device, comprising a memory, a processor and a computer program which is stored on the memory and runs on the processor, the processor, upon executing the program, implementing the above-mentioned method.

A computer-readable storage medium on which a computer program is stored, the program, when executed by the processor, implementing the aforesaid method.

As can be seen from the above introduction, the solutions of the present disclosure may be employed to distinguish data generated during travel of the self-driving vehicle into real-time data and non-real-time data, transmit the real-time data may into the server through the wireless network in real time, first store the non-real-time data in the vehicle-mounted storage device, and then, after the self-driving vehicle ends travel, store the data stored in the vehicle-mounted storage device into the server, thereby ensuring data integrity.

### BRIEF DESCRIPTION OF DRAWINGS

FIG. 1 is a flow chart of an embodiment of a method of transmitting data of a self-driving vehicle according to the present disclosure.

FIG. 2 is a schematic diagram of a manner of transmitting data of the self-driving vehicle according to the present disclosure.

FIG. 3 is a block diagram of an apparatus for transmitting data of a self-driving vehicle according to an embodiment of the present disclosure.

FIG. 4 illustrates a block diagram of an example computer system/server 12 adapted to implement an implementation mode of the present disclosure.

### DETAILED DESCRIPTION OF PREFERRED EMBODIMENTS

Technical solutions of the present disclosure will be described in more detail in conjunction with figures and embodiments to make technical solutions of the present disclosure clear and more apparent.

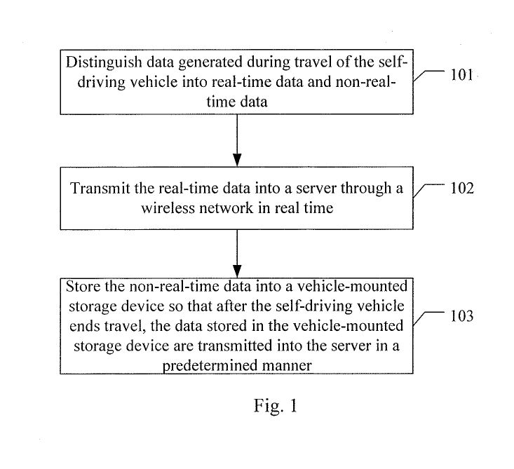

FIG. 1 is a flow chart of an embodiment of a method of transmitting data of a self-driving vehicle according to the present disclosure. As shown in FIG. 1, the embodiment comprises the following specific implementation mode:

At 101, data generated during travel of the self-driving vehicle are distinguished into real-time data and non-real-time data.

It is feasible to determine which data of a lot of data generated during travel of the self-driving vehicle as real-time data, and which data as non-real-time data according to actual needs.

For example, vehicle monitoring data and driving state data may be considered as real-time data to facilitate real-time mastery of the travel states of the vehicle.

Other data such as various sensor data and log of modules may be considered as non-real-time data.

At 102, the real-time data is transmitted into a server through a wireless network in real time.

The obtained real-time data may be transmitted in real time to the server of a data center through the wireless network.

As stated above, vehicle monitoring data and driving state data may be considered as real-time data. These data are usually in a smaller amount and therefore may be transmitted through the wireless network.

Preferably, it is further possible to employ a data security guaranty technology to transmit the real-time data into the server through the wireless network in real time to ensure security of data transmission.

For example, it is possible to use a technology such as a hypertext transmission protocol 2.0 to guarantee link reliability, and use an individual certificate check technology at a vehicle end and a server end to ensure data security.

At 103, the non-real-time data are stored into a vehicle-mounted storage device so that after the self-driving vehicle ends travel, the data stored in the vehicle-mounted storage device are transmitted into the server in a predetermined manner.

The non-real-time data may be temporarily stored in the vehicle-mounted storage device, and then, after the self-driving vehicle ends travel, the data temporarily stored in the vehicle-mounted storage device are further transmitted to the server.

As such, both the real-time data and non-real-time data are stored in the server, thereby ensuring the data integrity.

Specifically, non-real-time data at least may be processed in the following two manners.

1) Manner 1

The non-real-time data are stored in a vehicle-mounted storage device such as a mechanical hard disk or a solid-state hard disk. After the self-driving vehicle ends travel, the hard disk is drawn out of the vehicle and inserted in the server for data copying.

However, this manner is confronted with larger issues in practical application, for example, the server needs to be powered off and then powered on again upon the drawing and insertion of the hard disk; massive data cannot be transferred from an ordinary hard disk and stored into the server within a short period of time as the transmission speed of the ordinary hard disk is limited; manual intervention is needed in the whole process, for example, the hard disk is drawn and inserted manually and data are copied manually, that is to say, this causes various problems such as complexity, slow speed and high human power costs, and the above problems are particularly severe particularly when a large amount of data of the self-driving vehicle needs to be processed.

To this end, the present disclosure provides an improved processing manner, namely, storing non-real-time data into a vehicle-mounted nvme hard disk which is a hard disk having a nvme protocol interface.

Correspondingly, after the self-driving vehicle ends travel, the nvme may be inserted into a server that supports hot swap of the nvme hard disk, namely, inserted into the nvme server.

The nvme hard disk is characterized by extremely fast read/write rate, and meanwhile may cooperate with an automatic transmission system in the server that supports hot swap of the nvme hard disk to implement quick and automatic uploading of data.

The automatic transmission system may be provided in the server that supports hot swap of the nvme hard disk. After the nvme hard disk is inserted in the server that supports hot swap of the nvme hard disk, the automatic transmission system may be used to achieve automatic uploading of data.

The above manner does not require power off and restart of the server and can be implemented simply by directly drawing and inserting the hard disk. Furthermore, the manner can provide fast transmission, does not require manual operations such as manual data copying, and saves human power costs.

2) Manner 2

The non-real-time data are stored in a vehicle-mounted storage device. After the self-driving vehicle ends travel, the data in the vehicle-mounted storage device are transmitted into the server through optical fibers.

For example, after the self-driving vehicle is parked at a designed position, optical fibers led out of a server room are used to connect with the vehicle-mounted storage device so that the data stored in the vehicle-mounted storage device are transmitted into the server through the optical fibers.

This manner is implemented very quickly and efficiently.

In practical application, which one of the above manners is specifically used may depend on actual needs.

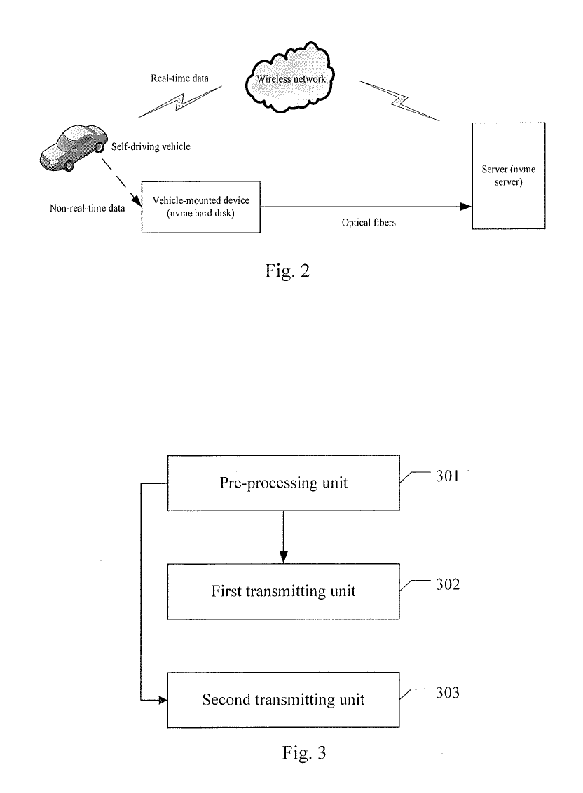

To conclude the above introduction, FIG. 2 is a schematic diagram of a manner of transmitting data of the self-driving vehicle according to the present disclosure. As shown in FIG. 2, data generated during travel of the self-driving vehicle are distinguished into real-time data and non-real-time data, the real-time data may be transmitted into the server in real time through the wireless network, the non-real-time data may be first stored in the vehicle-mounted storage device (located in the self-driving vehicle), and then transmitted into the server through the optical fibers, or the vehicle-mounted storage device is a nvme hard disk, and the non-real-time data are transmitted into the nvme server through the nvme hard disk.

The above introduces the method embodiment. The solution of the present disclosure will be further described through an apparatus embodiment.

FIG. 3 is a block diagram of an apparatus for transmitting data of a self-driving vehicle according to an embodiment of the present disclosure. As shown in FIG. 3, the apparatus comprises: a pre-processing unit 301, a first transmitting unit 302 and a second transmitting unit 303.

The pre-processing unit 301 is configured to distinguish data generated during travel of the self-driving vehicle into real-time data and non-real-time data, transmit the real-time data to the first transmitting unit 302, and transmit the non-real-time data to the second transmitting unit 303.

The first transmitting unit 302 is configured to transmit the real-time data into a server through a wireless network in real time.

The second transmitting unit 303 is configured to store the non-real-time data into a vehicle-mounted storage device so that after the self-driving vehicle ends travel, the data stored in the vehicle-mounted storage device are transmitted into the server in a predetermined manner.

The first transmitting unit 302 may employ a data security guaranty technology to transmit the real-time data into the server through the wireless network in real time.

The real-time data may comprise: vehicle monitoring data and driving state data.

The non-real-time data may be processed in the following at least two manners.

In the first manner, the second transmitting unit 303 may store the obtained non-real-time data into a vehicle-mounted nvme hard disk so that after the self-driving vehicle ends travel, the nvme may be inserted into a server that supports hot swap of the nvme hard disk, and automatic data transmission is performed.

The nvme hard disk is characterized by extremely fast read/write rate, and meanwhile may cooperate with an automatic transmission system in the server that supports hot swap of the nvme hard disk to implement quick and automatic uploading of data.

In the second manner, the second transmitting unit 303 may store the obtained non-real-time data in a vehicle-mounted storage device. After the self-driving vehicle ends travel, the data stored in the vehicle-mounted storage device are transmitted into the server through optical fibers.

Reference may be made to corresponding depictions in the above method embodiment for a specific workflow of the apparatus embodiment shown in FIG. 3, and not detailed depictions are given any more here.

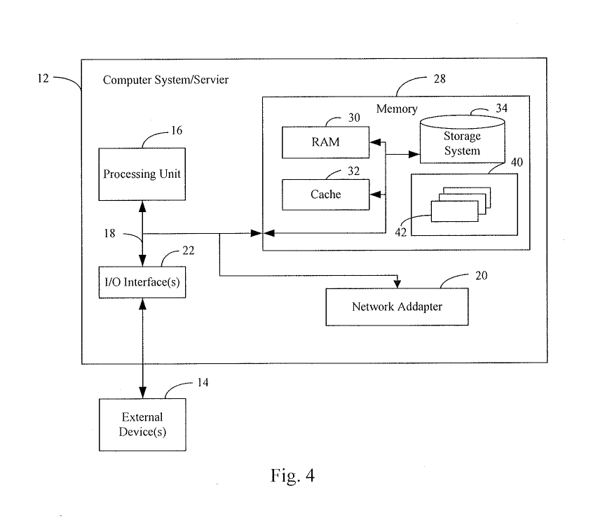

FIG. 4 illustrates a block diagram of an example computer system/server 12 adapted to implement an implementation mode of the present disclosure. The computer system/server 12 shown in FIG. 4 is only an example and should not bring about any limitation to the function and scope of use of the embodiments of the present disclosure.

As shown in FIG. 4, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 4 and typically called a “hard drive”). Although not shown in FIG. 4, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 4, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1, namely, distinguish data generated during travel of the self-driving vehicle into real-time data and non-real-time data, transmit the real-time data into a server through a wireless network in real time, and store the non-real-time data into a vehicle-mounted storage device so that after the self-driving vehicle ends travel, the data stored in the vehicle-mounted storage device are transmitted into the server in a predetermined manner.

Regarding the non-real-time data, it is possible to store the non-real-time data into a vehicle-mounted nvme hard disk so that after the self-driving vehicle ends travel, the nvme may be inserted into a server that supports hot swap of the nvme hard disk, and automatic data transmission is performed.

Or, it is possible to store the non-real-time data in a vehicle-mounted storage device. After the self-driving vehicle ends travel, the data stored in the vehicle-mounted storage device are transmitted into the server through optical fibers.

The present disclosure further provides a computer-readable storage medium on which a computer program is stored. The program, when executed by a processor, can implement the method in the embodiment shown in FIG. 1.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method of transmitting data of a self-driving vehicle, wherein the method comprises:
distinguishing data generated during travel of the self-driving vehicle into real-time data and non-real-time data;
transmitting the real-time data into a server through a wireless network in real time;
storing the non-real-time data into a vehicle-mounted storage device so that after the self-driving vehicle ends travel, the data stored in the vehicle-mounted storage device are transmitted into the server in a predetermined manner.

2. The method according to claim 1, wherein
the transmitting the real-time data into a server through a wireless network in real time comprises:
employing a data security guaranty technology to transmit the real-time data into the server through the wireless network in real time.

3. The method according to claim 1, wherein
the vehicle-mounted storage device comprises a nvme hard disk;
the server comprises a server that supports hot swap of the nvme hard disk;
the predetermined manner comprises: inserting the nvme hard disk into the server that supports hot swap of the nvme hard disk and performing automatic data transmission.

4. The method according to claim 1, wherein
the predetermined manner comprises optical fibers.

5. The method according to claim 1, wherein
the real-time data comprises: vehicle monitoring data and driving state data.

6-10. (canceled)

11. A computer device, comprising a memory, a processor and a computer program which is stored on the memory and runs on the processor, wherein the processor, upon executing the program, implements the following operations:
distinguishing data generated during travel of the self-driving vehicle into real-time data and non-real-time data;
transmitting the real-time data into a server through a wireless network in real time;
storing the non-real-time data into a vehicle-mounted storage device so that after the self-driving vehicle ends travel, the data stored in the vehicle-mounted storage device are transmitted into the server in a predetermined manner.

12. A computer-readable storage medium on which a computer program is stored, wherein the program, when executed by the processor, implements the following operations:
distinguishing data generated during travel of the self-driving vehicle into real-time data and non-real-time data;
transmitting the real-time data into a server through a wireless network in real time;
storing the non-real-time data into a vehicle-mounted storage device so that after the self-driving vehicle ends travel, the data stored in the vehicle-mounted storage device are transmitted into the server in a predetermined manner.

13. The computer device according to claim 11, wherein
the transmitting the real-time data into a server through a wireless network in real time comprises:
employing a data security guaranty technology to transmit the real-time data into the server through the wireless network in real time.

14. The computer device according to claim 11, wherein
the vehicle-mounted storage device comprises a nvme hard disk;
the server comprises a server that supports hot swap of the nvme hard disk;
the predetermined manner comprises: inserting the nvme hard disk into the server that supports hot swap of the nvme hard disk and performing automatic data transmission.

15. The computer device according to claim 11, wherein
the predetermined manner comprises optical fibers.

16. The computer device according to claim 11, wherein
the real-time data comprises: vehicle monitoring data and driving state data.

17. The computer-readable storage medium according to claim 12, wherein
the transmitting the real-time data into a server through a wireless network in real time comprises:
employing a data security guaranty technology to transmit the real-time data into the server through the wireless network in real time.

18. The computer-readable storage medium according to claim 12, wherein
the vehicle-mounted storage device comprises a nvme hard disk;
the server comprises a server that supports hot swap of the nvme hard disk;
the predetermined manner comprises: inserting the nvme hard disk into the server that supports hot swap of the nvme hard disk and performing automatic data transmission.

19. The computer-readable storage medium according to claim 12, wherein
the predetermined manner comprises optical fibers.

20. The computer-readable storage medium according to claim 12, wherein
the real-time data comprises: vehicle monitoring data and driving state data.
